(19) United States
(12) Patent Application Publication
(10) Pub. No.: US 2024/0012502 A1
(43) Pub. Date: Jan. 11, 2024

(54) IMAGE DISPLAY DEVICE AND DISPLAY SYSTEM

(71) Applicant: Sharp NEC Display Solutions, Ltd., Tokyo (JP)

(72) Inventor: Shinya NIIOKA, Tokyo (JP)

(21) Appl. No.: 18/234,751

(22) Filed: Aug. 16, 2023

Related U.S. Application Data
(63) Continuation of application No. PCT/JP2021/006875, filed on Feb. 24, 2021.

(51) Int. Cl. G06F 3/041; G06V 40/16

(52) U.S. Cl. CPC G06F 3/0416; G06F 3/0412; G06V 40/16

(57) ABSTRACT

An image display device including a display screen for displaying an image includes a touch switch arranged on the display screen, a touch position detection unit configured to detect a touch position and the number of touches of the display screen touched by a user of the image display device, a storage unit configured to store the touch position and the number of touches detected by the touch position detection unit, and a determination unit configured to determine a degree of contamination of the display screen on the basis of the touch position and the number of touches stored in the storage unit.

### TECHNICAL FIELD

The present invention relates to an image display device and a display system.

### BACKGROUND ART

Patent Document 1 describes a touch screen device having a touch screen attached to a front surface of a display, a position detection unit, a control unit, a storage unit, and a display processing unit.

In the technology described in Patent Document 1, information about a touched position on the touch screen is detected by a position detection unit as a coordinate value on the display and the coordinate data is sent from the touch screen to the control unit and saved in the storage unit. This coordinate data is stored so that a position on the touch screen touched by the operator can be understood. Also, the number of times the operator touches the touch screen is stored together with the coordinate data.

Also, in the technology described in Patent Document 1, when the number of touches on the touch screen reaches 100, a message for prompting someone or something to perform cleaning is displayed on the display and the operator can know that work of cleaning the touch screen has become necessary.

The number of touches of the operator after which work of cleaning the touch screen is required when the operator touching the touch screen is in poor health shall be set to be smaller than the number of touches of the operator after which work of cleaning the touch screen is required when the operator touching the touch screen is in good health.

However, in the technology described in Patent Document 1, a message for prompting someone or something to perform cleaning is generated and displayed on the display without considering a health state of the operator who touches the touch screen.

Thus, in the technology described in Patent Document 1, there may be a possibility of the touch screen cleaning work not being performed at an appropriate timing.

### CITATION LIST

### Patent Document

[Patent Document 1]

Japanese Unexamined Patent Application, First Publication No. 2010-230399

### SUMMARY OF INVENTION

### Technical Problem

In view of the above-described points, an objective of the present invention is to provide an image display device and a display system capable of accurately ascertaining a degree of contamination of a display screen.

### Solution to Problem

According to an aspect of the present invention, there is provided an image display device including a display screen for displaying an image, the image display device including: a touch switch arranged on the display screen; a touch position detection unit configured to detect a touch position and the number of touches of the display screen touched by a user of the image display device; a storage unit configured to store the touch position and the number of touches detected by the touch position detection unit; and a determination unit configured to determine a degree of contamination of the display screen on the basis of the touch position and the number of touches stored in the storage unit.

According to an aspect of the present invention, there is provided a display system including at least a first image display device configured to have a first display screen for displaying an image and a second image display device configured to have a second display screen for displaying an image, wherein the first image display device includes a first touch switch arranged on the first display screen; a first touch position detection unit configured to detect a touch position and the number of touches of the first display screen touched by a first user who is a user of the first image display device; a first storage unit configured to store the touch position and the number of touches detected by the first touch position detection unit; and a first determination unit configured to determine a degree of contamination of the first display screen on the basis of the touch position and the number of touches stored in the first storage unit, wherein the second image display device includes a second touch switch arranged on the second display screen; a second touch position detection unit configured to detect a touch position and the number of touches of the second display screen touched by a second user who is a user of the second image display device; a second storage unit configured to store the touch position and the number of touches detected by the second touch position detection unit; and a second determination unit configured to determine a degree of contamination of the second display screen on the basis of the touch position and the number of touches stored in the second storage unit, and wherein the degree of contamination of the first display screen determined by the first determination unit and the degree of contamination of the second display screen determined by the second determination unit are collected via a network and the first image display device and the second image display device are centrally managed.

### Advantageous Effects of Invention

According to the present invention, it is possible to accurately ascertain a degree of contamination of a display screen.

### BRIEF DESCRIPTION OF DRAWINGS

FIG. 1 is a diagram showing an example of a display system to which an image display device of a first embodiment is applied.

FIG. 2 is a diagram showing an example of the image display device of the first embodiment.

FIG. 3 is a flowchart for describing an example of a process executed in the image display device of the first embodiment and the like.

FIG. 4 is a diagram showing an example of a display system to which an image display device of a second embodiment is applied.

FIG. 5 is a diagram showing an example of the image display device of the second embodiment.

FIG. 6 is a diagram showing an example of a display screen of the image display device of the second embodiment.

FIG. 7 is a diagram showing an example of a touch position of a display screen touched by a user and the like.

FIG. 8 is a diagram showing an example of a display system to which an image display device of a third embodiment is applied.

FIG. 9 is a diagram showing an example of the image display device of the third embodiment.

FIG. 10 is a diagram showing an example of a display system to which an image display device of a fourth embodiment is applied.

FIG. 11 is a diagram showing an example of a display system to which an image display device of a fifth embodiment is applied.

FIG. 12 is a diagram showing an example of the image display device of the fifth embodiment.

### DESCRIPTION OF EMBODIMENTS

Hereinafter, embodiments of an image display device and a display system of the present invention will be described with reference to the drawings.

### First Embodiment

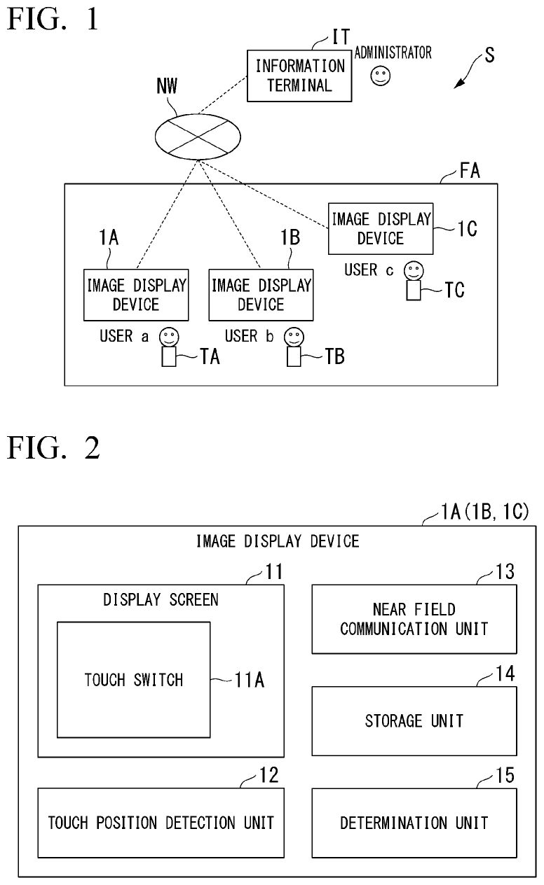

FIG. 1 is a diagram showing an example of a display system S to which image display devices 1A, 1B, and 1C of a first embodiment are applied. FIG. 2 is a diagram showing an example of the image display device 1A (1B or 1C) of the first embodiment.

In the examples shown in FIGS. 1 and 2, the display system S includes, for example, the image display device 1A, the image display device 1B, the image display device 1C, and an information terminal IT.

Although the display system S includes the three image display devices 1A, 1B, and 1C in the example shown in FIGS. 1 and 2, the number of image display devices provided in the display system S may be a number other than 3 in other examples.

In the examples shown in FIGS. 1 and 2, the image display device 1A, the image display device 1B, and the image display device 1C are arranged in an exhibition facility FA such as an art museum.

The image display device 1A is connected to the network NW and is used by a user a (for example, a user of the exhibition facility FA). The image display device 1B is connected to the network NW and is used by a user b (for example, a user of the exhibition facility FA). The image display device 1C is connected to the network NW and is used by a user c (for example, a user of the exhibition facility FA).

The information terminal IT is connected to the network NW and is used by the administrator of the image display device 1A, the image display device 1B, and the image display device 1C (for example, a cleaning staff member for the image display device 1A, the image display device 1B, and the image display device 1C).

As shown in FIG. 2, the image display device 1A includes, for example, a display screen 11, a touch position detection unit 12, a near field communication unit 13, a storage unit 14, and a determination unit 15. In other examples, the image display device 1A may not include the near field communication unit 13.

In the examples shown in FIGS. 1 and 2, the display screen 11 displays an image (for example, a guidance image for the exhibition facility FA). The display screen 11 includes a touch switch 11A. The touch switch 11A receives, for example, an input operation of the user a using the image display device 1A.

The touch position detection unit 12 detects the touch position and the number of touches of the display screen 11 (such as the touch switch 11A) touched by the user a.

The near field communication unit 13 acquires health management information of the user a from the portable terminal TA (see FIG. 1) located in close proximity to the image display device 1A. The portable terminal TA is, for example, a smartphone, a wearable device, or the like carried by the user a.

In the example in which the portable terminal TA is a smartphone, the near field communication unit 13 acquires health management information of the user a registered in (input to) the portable terminal TA by the user a in advance (for example, information indicating the body temperature of the user a and the like and virus infection information) from the portable terminal TA.

In the example in which the portable terminal TA is a wearable device, the near field communication unit 13 acquires health management information of the user a (for example, information indicating a body temperature of the user a and the like) measured and saved by the portable terminal TA from the portable terminal TA. In this example, the portable terminal TA (wearable device) may automatically extract the health management information such as the body temperature of the user a and transmit the health management information to the near field communication unit 13 of the image display device 1A.

The storage unit 14 stores the touch position and the number of touches of the display screen 11 detected by the touch position detection unit 12 and the health management information of the user a acquired by the near field communication unit 13. In the example in which the image display device 1A does not include the near field communication unit 13, the storage unit 14 stores the touch position and the number of touches of the display screen 11 detected by the touch position detection unit 12.

The determination unit 15 determines a degree of contamination of the display screen 11 on the basis of the touch position and the number of touches of the display screen 11 and the health management information of the user a stored in the storage unit 14. In the example in which the image display device 1A does not include the near field communication unit 13, the determination unit 15 determines a degree of contamination of the display screen 11 on the basis of the touch position and the number of touches of the display screen 11 stored in the storage unit 14. The determination unit 15 may perform a process of assigning a weight to the health management information of the user a acquired by the near field communication unit 13 to determine the degree of contamination of the display screen 11. For example, when the health management information of the user a acquired by the near field communication unit 13 is information obtained by recording a temperature change of the user a for 14 days or more, because the health management information of the user a acquired by the near field communication unit 13 is highly reliable, the determination unit 15 determines the degree of contamination of the display screen 11 by increasing a weight of the health management information of the user a acquired by the near field communication unit 13. The determination unit 15 determines a part that needs to be cleaned within the touch switch 11A on the basis of the degree of contamination of the display screen 11.

In the examples shown in FIGS. 1 and 2, the image display device 1B is configured like the image display device 1A. That is, the image display device 1B includes, for example, a display screen 11, a touch position detection unit 12, a near field communication unit 13, a storage unit 14, and a determination unit 15. In another example, the image display device 1B may not include the near field communication unit 13.

In the examples shown in FIGS. 1 and 2, the display screen 11 of the image display device 1B displays an image. The display screen 11 includes a touch switch 11A. The touch switch 11A receives, for example, input operations of a user b and the like using the image display device 1B.

The touch position detection unit 12 of the image display device 1B detects the touch position and the number of touches of the display screen 11 (such as the touch switch 11A) touched by the user b.

The near field communication unit 13 of the image display device 1B acquires health management information of the user b from a portable terminal TB (see FIG. 1) located in close proximity to the image display device 1B.

The storage unit 14 of the image display device 1B includes the touch position and the number of touches of the display screen 11 detected by the touch position detection unit 12 and the health management information of the user b acquired by the near field communication unit 13. In the example in which the image display device 1B does not include the near field communication unit 13, the storage unit 14 of the image display device 1B stores the touch position and the number of touches of the display screen 11 detected by the touch position detection unit 12.

The determination unit 15 of the image display device 1B determines the degree of contamination of the display screen 11 on the basis of the touch position and the number of touches of the display screen 11 and the health management information of the user b stored in the storage unit 14. In the example in which the image display device 1B does not include the near field communication unit 13, the determination unit 15 of the image display device 1B determines the degree of contamination of the display screen 11 on the basis of the touch position and the number of touches of the display screen 11 stored in the storage unit 14. The determination unit 15 of the image display device 1B determines a part that needs to be cleaned within the touch switch 11A on the basis of the degree of contamination of the display screen 11.

In another example, the configuration of the image display device 1B may be different from the configuration of the image display device 1A.

In the examples shown in FIGS. 1 and 2, the image display device 1C is configured like the image display device 1A. That is, the image display device 1C includes, for example, a display screen 11, a touch position detection unit 12, a near field communication unit 13, a storage unit 14, and a determination unit 15. In another example, the image display device 1C may not include the near field communication unit 13.

In the examples shown in FIGS. 1 and 2, the display screen 11 of the image display device 1C displays an image. The display screen 11 includes a touch switch 11A. The touch switch 11A receives, for example, an input operation of a user c and the like using the image display device 1C.

The touch position detection unit 12 of the image display device 1C detects the touch position and the number of touches of the display screen 11 (such as the touch switch 11A) touched by the user c.

The near field communication unit 13 of the image display device 1C acquires health management information of the user c from the portable terminal TC (see FIG. 1) located in close proximity to the image display device 1C.

The storage unit 14 of the image display device 1C stores the touch position and the number of touches of the display screen 11 detected by the touch position detection unit 12 and the health management information of the user c acquired by the near field communication unit 13. In the example in which the image display device 1C does not include the near field communication unit 13, the storage unit 14 of the image display device 1C stores the touch position and the number of touches of the display screen 11 detected by the touch position detection unit 12.

The determination unit 15 of the image display device 1C determines the degree of contamination of the display screen 11 on the basis of the touch position and the number of touches of the display screen 11 and the health management information of the user c stored in the storage unit 14. In the example in which the image display device 1C does not include the near field communication unit 13, the determination unit 15 of the image display device 1C determines the degree of contamination of the display screen 11 on the basis of the touch position and the number of touches of the display screen 11 stored in the storage unit 14. The determination unit 15 of the image display device 1C determines a part that needs to be cleaned within the touch switch 11A on the basis of the degree of contamination of the display screen 11.

In another example, the configuration of the image display device 1C may be different from the configuration of the image display device 1A.

In the examples shown in FIGS. 1 and 2, the degree of contamination of the display screen 11 of the image display device 1A determined by the determination unit 15 of the image display device 1A, the degree of contamination of the display screen 11 of the image display device 1B determined by the determination unit 15 of the image display device 1B, and the degree of contamination of the display screen 11 of the image display device 1C determined by the determination unit 15 of the image display device 1C are collected via the network NW and the image display device 1A, the image display device 1B, and the image display device 1C are centrally managed.

In detail, the information terminal IT connected to the image display device 1A, the image display device 1B, and the image display device 1C via the network NW centrally manages the degree of contamination of the display screen 11 of the image display device 1A determined by the determination unit 15 of the image display device 1A, the degree of contamination of the display screen 11 of the image display device 1B determined by the determination unit 15 of the image display device 1B, and the degree of contamination of the display screen 11 of the image display device 1C determined by the determination unit 15 of the image display device 1C.

The information terminal IT determines whether or not it is necessary to clean the display screen 11 of the image display device 1A on the basis of the degree of contamination of the display screen 11 of the image display device 1A determined by the determination unit 15 of the image display device 1A. When it is necessary to clean the display screen 11 of the image display device 1A, the information terminal IT provides a notification for prompting someone or something to clean the display screen 11 of the image display device 1A. Thus, the administrator using the information terminal IT can easily ascertain that it is necessary to clean the display screen 11 of the image display device 1A. That is, the administrator can accurately ascertain the degree of contamination of the display screen 11 of the image display device 1A at a remote position of the image display device 1A.

After the information terminal IT provides a notification for prompting someone or something to clean the display screen 11 of the image display device 1A, the image display device 1A displays content indicating that an input operation on the touch switch 11A is unnecessary on the display screen 11 without performing a display process of requesting the user a to perform an input operation on the touch switch 11A until cleaning of the display screen 11 of the image display device 1A is completed.

In another example, after the information terminal IT provides a notification for prompting someone or something to clean the display screen 11 of the image display device 1A, the image display device 1A may prohibit an input operation on the touch switch 11A until cleaning of the display screen 11 of the image display device 1A is completed.

In yet another example, after the information terminal IT provides a notification for prompting someone or something to clean the display screen 11 of the image display device 1A, the image display device 1A may not perform a process of displaying the display screen 11 of the image display device 1A until cleaning of the display screen 11 of the image display device 1A is completed.

The information terminal IT determines whether or not it is necessary to clean the display screen 11 of the image display device 1B on the basis of the degree of contamination of the display screen 11 of the image display device 1B determined by the determination unit 15 of the image display device 1B. When it is necessary to clean the display screen 11 of the image display device 1B, the information terminal IT provides a notification for prompting someone or something to clean the display screen 11 of the image display device 1B. Thus, the administrator using the information terminal IT can easily ascertain that it is necessary to clean the display screen 11 of the image display device 1B. That is, the administrator can accurately ascertain the degree of contamination of the display screen 11 of the image display device 1B at a remote position of the image display device 1B.

After the information terminal IT provides a notification for prompting someone or something to clean the display screen 11 of the image display device 1B, the image display device 1B displays content indicating that an input operation on the touch switch 11A is unnecessary on the display screen 11 without performing a display process of requesting the user b to perform an input operation on the touch switch 11A until cleaning of the display screen 11 of the image display device 1B is completed.

In another example, after the information terminal IT provides a notification for prompting someone or something to clean the display screen 11 of the image display device 1B, the image display device 1B may prohibit an input operation on the touch switch 11A until cleaning of the display screen 11 of the image display device 1B is completed.

In yet another example, after the information terminal IT provides a notification for prompting someone or something to clean the display screen 11 of the image display device 1B, the image display device 1B may not perform a process of displaying the display screen 11 of the image display device 1B until cleaning of the display screen 11 of the image display device 1B is completed.

The information terminal IT determines whether or not it is necessary to clean the display screen 11 of the image display device 1C on the basis of the degree of contamination of the display screen 11 of the image display device 1C determined by the determination unit 15 of the image display device 1C. When it is necessary to clean the display screen 11 of the image display device 1C, the information terminal IT provides a notification for prompting someone or something to clean the display screen 11 of the image display device 1C. Thus, the administrator using the information terminal IT can easily ascertain that it is necessary to clean the display screen 11 of the image display device 1C. That is, the administrator can accurately ascertain the degree of contamination of the display screen 11 of the image display device 1C at a remote position of the image display device 1C.

After the information terminal IT provides a notification for prompting someone or something to clean the display screen 11 of the image display device 1C, the image display device 1C displays content indicating that an input operation on the touch switch 11A is unnecessary on the display screen 11 without performing a display process of requesting the user c to perform an input operation on the touch switch 11A until cleaning of the display screen 11 of the image display device 1C is completed.

In another example, after the information terminal IT provides a notification for prompting someone or something to clean the display screen 11 of the image display device 1C, the image display device 1C may prohibit an input operation on the touch switch 11A until cleaning of the display screen 11 of the image display device 1C is completed.

In yet another example, after the information terminal IT provides a notification for prompting someone or something to clean the display screen 11 of the image display device 1C, the image display device 1C may not perform a process of displaying the display screen 11 of the image display device 1C until cleaning of the display screen 11 of the image display device 1C is completed.

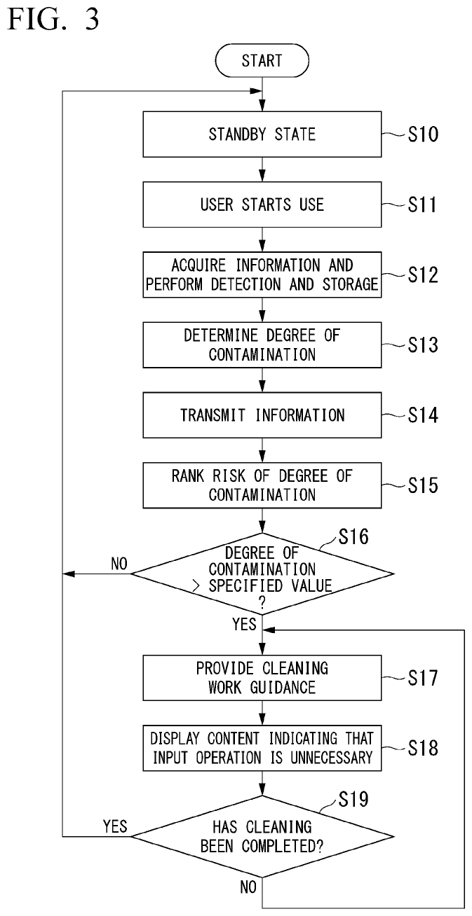

FIG. 3 is a flowchart for describing an example of a process executed in the image display device 1A or the like of the first embodiment.

The routine shown in FIG. 3 is started, for example, at the start of business of the exhibition facility FA or the like.

In the example shown in FIG. 3, in step S10, the image display devices 1A, 1B, and 1C and the information terminal IT are in a standby state.

Subsequently, in step S11, the user a starts the use of the image display device 1A.

Subsequently, in step S12, the image display device 1A acquires and saves usage information. Specifically, the near field communication unit 13 of the image display device 1A acquires health management information of the user a from the portable terminal TA. Also, the touch position detection unit 12 of the image display device 1A detects the touch position and the number of touches of the display screen 11 touched by the user a. Furthermore, the storage unit 14 of the image display device 1A stores the health management information of the user a acquired by the near field communication unit 13 and the touch position and the number of touches of the display screen 11 acquired by the touch position detection unit 12.

Subsequently, in step S13, the determination unit 15 of the image display device 1A determines the degree of contamination of the display screen 11 on the basis of history information (i.e., the touch position and the number of touches of the display screen 11 and the health management information of the user a stored in the storage unit 14).

Subsequently, in step S14, the image display device 1A transmits information about the degree of contamination of the display screen 11 determined in step S13 to the information terminal IT.

Subsequently, in step S15, the information terminal IT ranks a risk of the degree of contamination of the image display device 1A received in step S14 (information about the degree of contamination of the display screen 11 of the image display device 1A).

Subsequently, in step S16, the information terminal IT determines whether or not the degree of contamination of the display screen 11 of the image display device 1A exceeds a specified value (a predetermined threshold value). When the degree of contamination of the display screen 11 of the image display device 1A exceeds the specified value, the process proceeds to step S17. On the other hand, when the degree of contamination of the display screen 11 of the image display device 1A does not exceed the specified value, the process returns to step S10.

In step S17, the information terminal IT provides a notification of guidance of work to clean the image display device 1A (a notification for prompting someone or something to clean the display screen 11 of the image display device 1A) and the administrator receives the notification.

Also, in step S18, the image display device 1A displays content indicating that an input operation on the touch switch 11A is unnecessary on the display screen 11 without performing a display process of requesting the user a to perform the input operation on the touch switch 11A (i.e., the interactive content is stopped and the user a is not guided to perform touch work).

Subsequently, in step S19, for example, the information terminal IT determines whether or not the work to clean the image display device 1A has been completed. When the work to clean the image display device 1A has been completed, the degree of contamination of the display screen 11 of the image display device 1A is reset (i.e., reduced to zero), and the process returns to step S10. On the other hand, when the work to clean the image display device 1A has not been completed, the process returns to step S17.

The routine shown in FIG. 3 ends, for example, at the end of business of the exhibition facility FA or the like.

As described above, in the display system S of the first embodiment, the degrees of contamination of the display screens 11 of the image display devices 1A, 1B, and 1C are analyzed on the basis of the touch positions and the number of touches of the display screens 11 of the image display devices 1A, 1B, and 1C and the health management information of the users a, b, and c. Thus, the degrees of contamination of the display screens 11 of the image display devices 1A, 1B, and 1C can be accurately ascertained. That is, the reliability of the data indicating the degrees of contamination of the display screens 11 of the image display devices 1A, 1B, and 1C is improved.

Also, in the display system S of the first embodiment, in a large-scale exhibition facility FA or the like that requires centralized management of the plurality of image display devices 1A, 1B, and 1C, it is possible to clarify which of the image display devices 1A, 1B, and 1C needs to be preferentially cleaned even if an unspecified number of users a, b, and c use the plurality of image display devices 1A, 1B, and 1C and it is possible to significantly improve the workability of a cleaning staff member.

That is, in the display system S of the first embodiment, the degrees of contamination of the display screens 11 of the image display devices 1A, 1B, and 1C are centrally managed (i.e., cleaned states such as disinfections of the display screens 11 of the image display devices 1A, 1B, and 1C are centrally managed). Also, a notification for prompting someone or something to clean the display screens 11 of the image display devices 1A, 1B, and 1C is provided to the administrator by the information terminal IT. Furthermore, until cleaning of the display screens 11 of the image display devices 1A, 1B, and 1C that need to be cleaned is completed, content indicating that the input operations of the users a, b, and c on the touch switches 11A of the image display devices 1A, 1B, and 1C are unnecessary is automatically displayed.

In another example of the display system S of the first embodiment, the display screens 11 of the image display devices 1A, 1B, and 1C may display images for prompting the users a, b, and c who touch the display screens 11 of the image display devices 1A, 1B, and 1C to pay attention. In this example, when the images for prompting the users to pay attention are not displayed on the display screens 11 of the image display devices 1A, 1B, and 1C, the users a, b, and c can touch the display screens 11 of the image display devices 1A, 1B, and 1C at ease.

Also, in the display system S of the first embodiment, when the degrees of contamination of the display screens 11 of the image display devices 1A, 1B, and 1C determined by the determination units 15 of the image display devices 1A, 1B, and 1C exceed the specified value (the predetermined threshold value), the administrator (the cleaning staff member) cleans the display screens 11 of the image display devices 1A, 1B, and 1C.

Thus, it is possible to suppress the risk that the display screens 11 of the image display devices 1A, 1B, and 1C, which are not touched by the user and do not need to be cleaned, may be cleaned by the administrator (the cleaning staff member). As a result, the workability of the administrator (the cleaning staff member) can be improved and cleaning maintenance costs can be suppressed.

### Second Embodiment

Hereinafter, a second embodiment of an image display device and a display system of the present invention will be described.

A display system S of the second embodiment is configured like the display system S of the first embodiment described above, except for differences to be described below. Accordingly, according to the display system S of the second embodiment, effects similar to those of the display system S of the first embodiment described above can be obtained, except for differences to be described below.

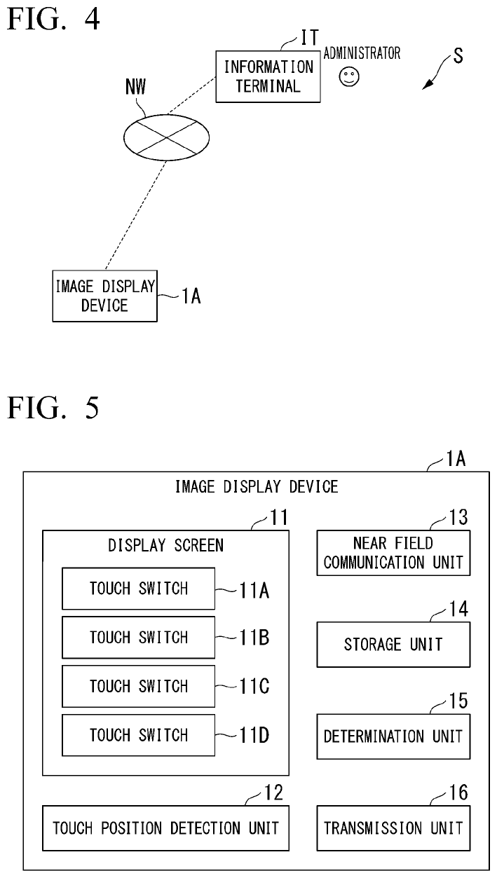

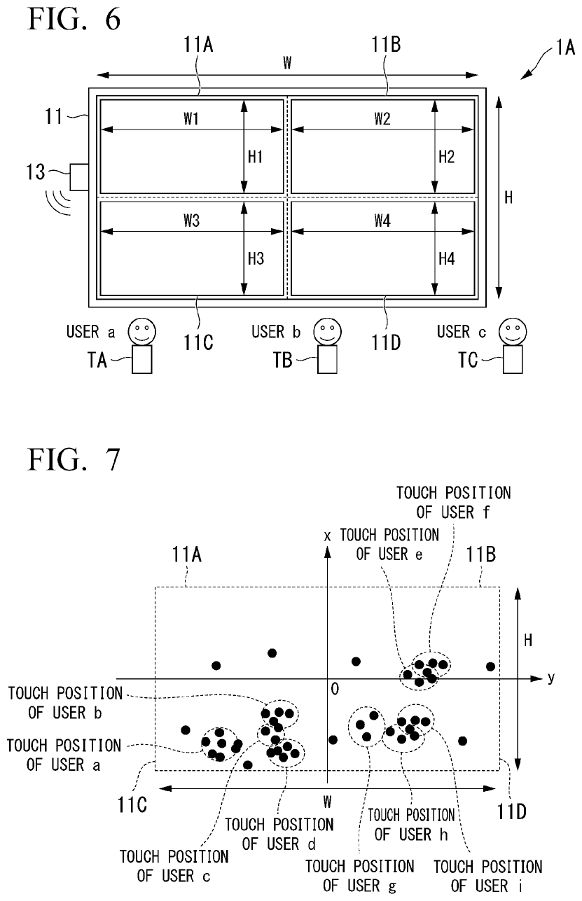

FIG. 4 is a diagram showing an example of the display system S to which a image display device 1A of the second embodiment is applied. FIG. 5 is a diagram showing an example of the image display device 1A of the second embodiment. FIG. 6 is a diagram showing an example of a display screen 11 of the image display device 1A of the second embodiment. FIG. 7 shows an example of touch positions of the display screen 11 touched by users a, b, and c, and the like.

In the example shown in FIGS. 4 to 7, the display system S includes, for example, the image display device 1A and an information terminal IT.

The image display device 1A is connected to the network NW and is used by users a, b, c, d, e, f, g, h, and i (see FIG. 7).

Although the image display device 1A is used by the nine users a to i in the examples shown in FIGS. 4 to 7, the image display device 1A may be used by any number of users other than 9 in other examples.

As shown in FIG. 5, the image display device 1A includes, for example, a display screen 11, a touch position detection unit 12, a near field communication unit 13, a storage unit 14, a determination unit 15, and a transmission unit 16.

The display screen 11 displays an image. The display screen 11 includes a plurality of touch switches 11A, 11B, 11C, and 11D (see FIG. 6). The plurality of touch switches 11A, 11B, 11C, and 11D are tiled. The touch switches 11A to 11D receive, for example, input operations of the plurality of users a to i using the image display device 1A.

The touch position detection unit 12 detects the touch position and the number of touches of the display screen 11 touched by each of the plurality of users a to i for each user.

The near field communication unit 13 acquires health management information of the user a from the portable terminal TA (see FIG. 6) located in close proximity to the image display device 1A. The portable terminal TA is, for example, a smartphone, a wearable device, or the like carried by the user a.

The near field communication unit 13 is located in close proximity to the image display device 1A and acquires health management information of the user b from the portable terminal TB (see FIG. 6) carried by the user b. Also, the near field communication unit 13 is located in close proximity to the image display device 1A and acquires health management information of the user c from the portable terminal TC (see FIG. 6) carried by the user c.

Likewise, the near field communication unit 13 is located in close proximity to the image display device 1A and acquires health management information of the user d from a portable terminal (not shown) carried by the user d. The near field communication unit 13 is located in close proximity to the image display device 1A and acquires health management information of the user e from a portable terminal (not shown) carried by the user e. The near field communication unit 13 is located in close proximity to the image display device 1A and acquires health management information of the user f from a portable terminal (not shown) carried by the user f The near field communication unit 13 is located in close proximity to the image display device 1A and acquires health management information of the user g from a portable terminal (not shown) carried by the user g. The near field communication unit 13 is located in close proximity to the image display device 1A and acquires health management information of the user h from a portable terminal (not shown) carried by the user h. The near field communication unit 13 is located in close proximity to the image display device 1A and acquires health management information of the user i from a portable terminal (not shown) carried by the user i.

The storage unit 14 stores the touch position and the number of touches of the display screen 11 touched by each of the plurality of users a to i detected for each user by the touch position detection unit 12 and the health management information of each of the users a to i acquired by the near field communication unit 13.

The determination unit 15 determines the degree of contamination of the touch position of the display screen 11 touched by each of the plurality of users a to i for each user on the basis of the touch position and the number of touches of the display screen 11 touched by each of the plurality of users a to i and the health management information of each of the plurality of users a to i. Also, the determination unit 15 determines a part that needs to be cleaned among the plurality of touch switches 11A, 11B, 11C, and 11D (the touch switches 11C and 11D in the example shown in FIG. 7) on the basis of the degree of contamination of the touch position of the display screen 11 touched by each of the plurality of users a to i determined for each user. In detail, the determination unit 15 determines a cleaning order of parts that need to be cleaned (touch switch 11C→touch switch 11D in the example shown in FIG. 7) on the basis of the degree of contamination of the touch position of the display screen 11 touched by each of the plurality of users a to i determined for each user.

The cleaning order of the parts that need to be cleaned is determined on the basis of a contamination risk of each of the plurality of users a to i that touch the display screen 11, the number of touches of the display screen 11 touched by each of the plurality of users a to i, and the like.

The transmission unit 16 transmits information indicating parts that need to be cleaned determined by the determination unit 15 (the touch switches 11C and 11D in the example shown in FIG. 7) to the information terminal IT. In detail, the transmission unit 16 transmits a cleaning order of parts that need to be cleaned determined by the determination unit 15 (touch switch 11C→touch switch 11D in the example shown in FIG. 7) to the information terminal IT.

In the example shown in FIG. 6, the display screen 11 of the image display device 1A has a width direction dimension W and a height direction dimension H. The touch switch 11A of the display screen 11 has a width direction dimension W1 and a height direction dimension H1, the touch switch 11B of the display screen 11 has a width direction dimension W2 and a height direction dimension H2, the touch switch 11C of the display screen 11 has a width direction dimension W3 and a height direction dimension H3, and the touch switch 11D of the display screen 11 has a width direction dimension W4 and a height direction dimension H4.

In the example shown in FIG. 7, the touch position detection unit 12 detects that the touch switch 11C of the display screen 11 has been touched seven times by the user a. Also, the touch position detection unit 12 detects that the touch switch 11C of the display screen 11 has been touched four times by the user b, the touch switch 11C of the display screen 11 has been touched three times by the user c, and the touch switch 11C of the display screen 11 has been touched five times by the user d.

The touch position detection unit 12 detects that each of the touch switches 11B and 11D of the display screen 11 has been touched twice by the user e. Also, the touch position detection unit 12 detects that the touch switch 11B of the display screen 11 has been touched three times by the user f.

The touch position detection unit 12 detects that the touch switch 11D of the display screen 11 has been touched three times by the user g. Also, the touch position detection unit 12 detects that the touch switch 11D of the display screen 11 has been touched four times by the user h and that the touch switch 11D of the display screen 11 has been touched three times by the user i.

In FIG. 7, the origin is an intersection between a boundary line between the touch switches 11A and 11B and the touch switches 11C and 11D (represented by the y-axis in FIG. 7) and a boundary line between the touch switches 11A and 11C and the touch switches 11B and 11D (represented by the x-axis in FIG. 7) and is a central portion of the display screen 11.

In the example shown in FIGS. 4 to 7, the information terminal IT connected to the image display device 1A via the network NW manages the degree of contamination of the display screen 11 of the image display device 1A determined by the determination unit 15 of the image display device 1A.

When it is necessary to clean the display screen 11 of the image display device 1A, the information terminal IT provides a notification for prompting someone or something to clean the display screen 11 of the image display device 1A. Thus, the administrator using the information terminal IT can easily ascertain that it is necessary to clean the display screen 11 of the image display device 1A. That is, the administrator can accurately ascertain the degree of contamination of the display screen 11 of the image display device 1A at a remote position of the image display device 1A.

Also, the information terminal IT provides a notification related to parts that need to be cleaned determined by the determination unit 15 (the touch switches 11C and 11D in the example shown in FIG. 7). In detail, the information terminal IT provides a notification related to a cleaning order of the parts that need to be cleaned determined by the determination unit 15 (touch switch 11C→touch switch 11D in the example shown in FIG. 7). Thus, the administrator using the information terminal IT can easily ascertain the presence or absence of a part that needs to be cleaned and the cleaning order of the parts that need to be cleaned.

After the information terminal IT provides a notification for prompting someone or something to clean the touch switches 11A to 11D of the display screen 11 of the image display device 1A, the image display device 1A displays content indicating that an input operation on the touch switches 11A to 11D is unnecessary on the display screen 11 without performing a display process of requesting the users a to i to perform an input operation on the touch switches 11A to 11D until cleaning of the touch switches 11A to 11D of the display screen 11 of the image display device 1A is completed.

As described above, in the display system S of the second embodiment, the degrees of contamination of the touch switches 11A to 11D of the display screen 11 of the image display device 1A are analyzed on the basis of touch positions and the number of touches of the touch switches 11A to 11D of the display screen 11 of the image display device 1A and health management information of the users a to i. Thus, the degrees of contamination of the touch switches 11A to 11D of the display screen 11 of the image display device 1A can be accurately ascertained. That is, the reliability of the data indicating the degree of contamination of the display screen 11 (i.e., a large screen including the touch switches 11A to 11D) of the image display device 1A is improved.

Also, even if an unspecified number of users a to i use a plurality of touch switches 11A to 11D of the display screen 11 of the image display device 1A in the display system S of the second embodiment, it is possible to clarify which of the touch switches 11A to 11D needs to be preferentially cleaned and it is possible to significantly improve the workability of a cleaning staff member.

That is, in the display system S of the second embodiment, the degrees of contamination of the plurality of touch switches 11A to 11D of the display screen 11 of the image display device 1A are managed (i.e., cleaned states such as disinfections of the plurality of touch switches 11A to 11D of the display screen 11 of the image display device 1A are managed). Also, a notification for prompting someone or something to clean the plurality of touch switches 11A to 11D of the display screen 11 of the image display device 1A is provided to the administrator by the information terminal IT. Furthermore, until cleaning of the touch switches 11A to 11D of the display screen 11 of the image display device 1A that needs to be cleaned is completed, content indicating that input operations of the users a to i on the touch switches 11A to 11D of the image display device 1A are unnecessary is automatically displayed.

In another example of the display system S of the second embodiment, the display screen 11 of the image display device 1A may display an image for prompting the users a to i who touch the touch switches 11A to 11D of the display screen 11 of the image display device 1A to pay attention. In this example, when the image for prompting someone or something to pay attention is not displayed on the display screen 11 of the image display device 1A, the users a to i can touch the touch switches 11A to 11D of the display screen 11 of the image display device 1A at ease.

Also, in the display system S of the second embodiment, when the degrees of contamination of the touch switches 11A to 11D of the display screen 11 of the image display device 1A determined by the determination unit 15 of the image display device 1A exceed a specified value (a predetermined threshold value), the touch switches 11A to 11D of the display screen 11 of the image display device 1A are cleaned by the administrator (the cleaning staff member).

Thus, it is possible to suppress the risk that the touch switches 11A to 11D of the display screen 11 of the image display device 1A, which is not touched by the user and does not need to be cleaned, may be cleaned by the administrator (the cleaning staff member). As a result, the workability of the administrator (the cleaning staff member) can be improved and cleaning maintenance costs can be suppressed.

### Third Embodiment

Hereinafter, a third embodiment of an image display device and a display system of the present invention will be described.

A display system S of the third embodiment is configured like the display system S of the first embodiment described above, except for differences to be described below. Accordingly, according to the display system S of the third embodiment, effects similar to those of the display system S of the first embodiment described above can be obtained, except for differences to be described below.

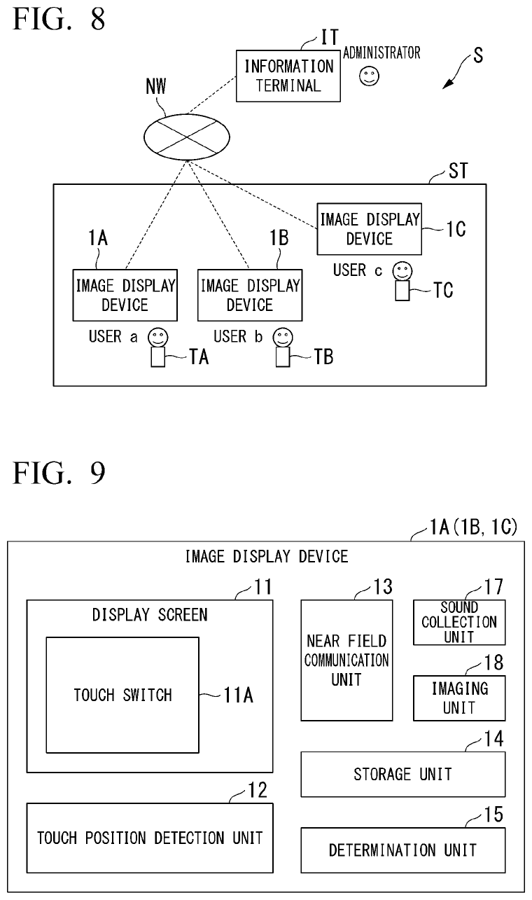

FIG. 8 is a diagram showing an example of the display system S to which image display devices 1A, 1B, and 1C of the third embodiment are applied. FIG. 9 is a diagram showing an example of the image display device 1A (1B or 1C) of the third embodiment.

In the examples shown in FIGS. 8 and 9, the display system S includes, for example, the image display device 1A, the image display device 1B, the image display device 1C, and an information terminal IT. The image display device 1A, the image display device 1B, and the image display device 1C are arranged in a shop ST.

The image display device 1A is connected to a network NW and is used by a user a (for example, a user of the shop ST). The image display device 1B is connected to the network NW and is used by a user b (for example, a user of the shop ST). The image display device 1C is connected to the network NW and is used by a user c (for example, a user of the shop ST).

The information terminal IT is connected to the network NW and is used by an administrator of the image display device 1A, the image display device 1B, and the image display device 1C (for example, a cleaning staff member for the image display device 1A, the image display device 1B, and the image display device 1C).

As shown in FIG. 9, the image display device 1A includes, for example, a display screen 11, a touch position detection unit 12, a near field communication unit 13, a storage unit 14, a determination unit 15, a sound collection unit 17, and an imaging unit 18.

The display screen 11 displays an image (for example, an image for describing a product displayed on a product display shelf of the shop ST). The display screen 11 includes a touch switch 11A. The touch switch 11A receives, for example, an input operation of the user a using the image display device 1A.

The touch position detection unit 12 detects a touch position and the number of touches of the display screen 11 touched by the user a.

The near field communication unit 13 acquires health management information of the user a from the portable terminal TA (see FIG. 8) located in close proximity to the image display device 1A. The portable terminal TA is, for example, a smartphone, a wearable device, or the like carried by the user a.

The sound collection unit 17 collects a voice produced by the user a. The imaging unit 18 captures an image of the user a.

The storage unit 14 stores the touch position and the number of touches of the display screen 11 detected by the touch position detection unit 12, the health management information of the user a acquired by the near field communication unit 13, the voice produced by the user a collected by the sound collection unit 17, and the image of the user a imaged by the imaging unit 18. In another example, the storage unit 14 may store the voice produced by the user a collected by the sound collection unit 17 and the image of the user a imaged by the imaging unit 18.

The determination unit 15 determines the degree of contamination of the display screen 11 on the basis of the touch position and the number of touches of the display screen 11, the health management information of the user a, the voice produced by the user a, and the image of the user a stored in the storage unit 14. In another example, the determination unit 15 may determine the degree of contamination of the display screen 11 on the basis of the voice produced by the user a and the image of the user a stored in the storage unit 14.

In detail, the determination unit 15 determines whether or not the user a is wearing a mask on the basis of the image of the user a stored in the storage unit 14. Also, the determination unit 15 determines a droplet risk on the basis of the voice produced by the user a stored in the storage unit 14. The determination unit 15 determines the degree of contamination of the display screen 11 by reflecting a result of determining whether or not the user a is wearing a mask and a result of determining the droplet risk.

In the examples shown in FIGS. 8 and 9, the image display device 1B is configured like the image display device 1A. That is, the image display device 1B includes, for example, a display screen 11, a touch position detection unit 12, a near field communication unit 13, a storage unit 14, a determination unit 15, a sound collection unit 17, and an imaging unit 18.

The display screen 11 of the image display device 1B displays an image (in detail, an image for describing a product displayed on a product display shelf different from the product display shelf described by the image displayed on the display screen 11 of the image display device 1A or the like). The display screen 11 includes a touch switch 11A. The touch switch 11A receives, for example, input operations of the user b and the like using the image display device 1B.

The touch position detection unit 12 of the image display device 1B detects a touch position and the number of touches of the display screen 11 touched by the user b.

The near field communication unit 13 of the image display device 1B acquires health management information of the user b from a portable terminal TB (see FIG. 8) located in close proximity to the image display device 1B.

The sound collection unit 17 of the image display device 1B collects a voice produced by the user b. The imaging unit 18 of the image display device 1B captures an image of the user b.

The storage unit 14 of the image display device 1B stores the touch position and the number of touches of the display screen 11 detected by the touch position detection unit 12, the health management information of the user b acquired by the near field communication unit 13, the voice produced by the user b collected by the sound collection unit 17, and the image of the user b captured by the imaging unit 18. In another example, the storage unit 14 of the image display device 1B may store the voice produced by the user b collected by the sound collection unit 17 and the image of the user b imaged by the imaging unit 18.

The determination unit 15 of the image display device 1B determines the degree of contamination of the display screen 11 on the basis of the touch position and the number of touches of the display screen 11, the health management information of the user b, the voice produced by the user b, and the image of the user b stored in the storage unit 14. In detail, the determination unit 15 of the image display device 1B determines the degree of contamination of the display screen 11 by reflecting a result of determining whether or not the user b is wearing a mask and a result of determining the droplet risk. In another example, the determination unit 15 of the image display device 1B may determine the degree of contamination of the display screen 11 on the basis of the voice produced by the user b and the image of the user b stored in the storage unit 14.

In another example, the configuration of the image display device 1B may be different from the configuration of the image display device 1A.

In the examples shown in FIGS. 8 and 9, the image display device 1C is configured like the image display device 1A. That is, the image display device 1C includes, for example, a display screen 11, a touch position detection unit 12, a near field communication unit 13, a storage unit 14, a determination unit 15, a sound collection unit 17, and an imaging unit 18.

The display screen 11 of the image display device 1C displays an image (in detail, an image for describing a product displayed on a product display shelf different from the product display shelves described by the images displayed on the display screens 11 of the image display devices 1A and 1B or the like). The display screen 11 includes a touch switch 11A. The touch switch 11A receives, for example, input operations of the user c and the like using the image display device 1C.

The touch position detection unit 12 of the image display device 1C detects a touch position and the number of touches of the display screen 11 touched by the user c.

The near field communication unit 13 of the image display device 1C acquires health management information of the user c from a portable terminal TC (see FIG. 8) located in close proximity to the image display device 1C.

The sound collection unit 17 of the image display device 1C collects a voice produced by the user c. The imaging unit 18 of the image display device 1C captures an image of the user c.

The storage unit 14 of the image display device 1C stores the touch position and the number of touches of the display screen 11 detected by the touch position detection unit 12, the health management information of the user c acquired by the near field communication unit 13, the voice produced by the user c collected by the sound collection unit 17, and the image of the user c captured by the imaging unit 18. In another example, the storage unit 14 of the image display device 1C may store the voice produced by the user c collected by the sound collection unit 17 and the image of the user c imaged by the imaging unit 18.

The determination unit 15 of the image display device 1C determines the degree of contamination of the display screen 11 on the basis of the touch position and the number of touches of the display screen 11, the health management information of the user c, the voice produced by the user c, and the image of the user c stored in the storage unit 14. In detail, the determination unit 15 of the image display device 1C determines the degree of contamination of the display screen 11 by reflecting a result of determining whether or not the user c is wearing a mask and a result of determining the droplet risk. In another example, the determination unit 15 of the image display device 1C may determine the degree of contamination of the display screen 11 on the basis of the voice produced by the user c and the image of the user c stored in the storage unit 14.

In other examples, the configuration of the image display device 1C may be different from the configuration of the image display device 1A.

In the examples shown in FIGS. 8 and 9, the information terminal IT connected to the image display device 1A, the image display device 1B, and the image display device 1C via the network NW centrally manages the degree of contamination of the display screen 11 of the image display device 1A determined by the determination unit 15 of the image display device 1A, the degree of contamination of the display screen 11 of the image display device 1B determined by the determination unit 15 of the image display device 1B, and the degree of contamination of the display screen 11 of the image display device 1C determined by the determination unit 15 of the image display device 1C.

The information terminal IT determines whether or not it is necessary to clean the display screen 11 of the image display device 1A on the basis of the degree of contamination of the display screen 11 of the image display device 1A determined by the determination unit 15 of the image display device 1A. When it is necessary to clean the display screen 11 of the image display device 1A, the information terminal IT provides a notification for prompting someone or something to clean the display screen 11 of the image display device 1A.

After the information terminal IT provides a notification for prompting someone or something to clean the display screen 11 of the image display device 1A, the image display device 1A displays content indicating that an input operation on the touch switch 11A is unnecessary on the display screen 11 without performing a display process of requesting the user a to perform an input operation on the touch switch 11A until cleaning of the display screen 11 of the image display device 1A is completed.

The information terminal IT determines whether or not it is necessary to clean the display screen 11 of the image display device 1B on the basis of the degree of contamination of the display screen 11 of the image display device 1B determined by the determination unit 15 of the image display device 1B. When it is necessary to clean the display screen 11 of the image display device 1B, the information terminal IT provides a notification for prompting someone or something to clean the display screen 11 of the image display device 1B.

After the information terminal IT provides a notification for prompting someone or something to clean the display screen 11 of the image display device 1B, the image display device 1B displays content indicating that an input operation on the touch switch 11A is unnecessary on the display screen 11 without performing a display process of requesting the user a to perform an input operation on the touch switch 11A until cleaning of the display screen 11 of the image display device 1B is completed.

The information terminal IT determines whether or not it is necessary to clean the display screen 11 of the image display device 1C on the basis of the degree of contamination of the display screen 11 of the image display device 1C determined by the determination unit 15 of the image display device 1C. When it is necessary to clean the display screen 11 of the image display device 1C, the information terminal IT provides a notification for prompting someone or something to clean the display screen 11 of the image display device 1C.

After the information terminal IT provides a notification for prompting someone or something to clean the display screen 11 of the image display device 1C, the image display device 1C displays content indicating that an input operation on the touch switch 11A is unnecessary on the display screen 11 without performing a display process of requesting the user a to perform an input operation on the touch switch 11A until cleaning of the display screen 11 of the image display device 1C is completed.

That is, in the display system S of the third embodiment, the degrees of contamination of the display screens 11 of the image display devices 1A, 1B, and 1C are centrally managed. Also, a notification for prompting someone or something to clean the display screens 11 of the image display devices 1A, 1B, and 1C is provided to the administrator by the information terminal IT. Furthermore, until cleaning of the display screens 11 of the image display devices 1A, 1B, and 1C that need to be cleaned is completed, content indicating that the input operations of the users a, b, and c on the touch switches 11A of the image display devices 1A, 1B, and 1C are unnecessary is automatically displayed.

In another example of the display system S of the third embodiment, the display screens 11 of the image display devices 1A, 1B, and 1C may display images for prompting the users a, b, and c who touch the display screens 11 of the image display devices 1A, 1B, and 1C to pay attention. In this example, when the images for prompting the users to pay attention are not displayed on the display screens 11 of the image display devices 1A, 1B, and 1C, the users a, b, and c can touch the display screens 11 of the image display devices 1A, 1B, and 1C at ease.

Also, in the display system S of the third embodiment, when the degrees of contamination of the display screens 11 of the image display devices 1A, 1B, and 1C determined by the determination units 15 of the image display devices 1A, 1B, and 1C exceed a specified value, the administrator cleans the display screens 11 of the image display devices 1A, 1B, and 1C.

In the example shown in FIG. 8 of the display system S of the third embodiment, the plurality of users a, b, and c are shopping and the determination units 15 of the image display devices 1A, 1B, and 1C determine whether or not the users a, b, and c are wearing the masks on the basis of the images of the users a, b, and c captured by the imaging units 18 of the image display devices 1A, 1B, and 1C. Also, the determination units 15 of the image display devices 1A, 1B, and 1C estimate the number of users who are talking on the basis of the sounds uttered by the users a, b, and c collected by the sound collection units 17 of the image display devices 1A, 1B, and 1C and the images captured by the imaging units 18 of the image display devices 1A, 1B, and 1C and determine the droplet risk on the basis of information thereof.

In the display system S of the third embodiment, interactive product information can be provided to the users a, b, and c through the touch functions of the touch switches 11A of the image display devices 1A, 1B, and 1C.

Furthermore, in the display system S of the third embodiment, the risk when an unspecified user touches the display screens 11 of the image display devices 1A, 1B, and 1C can be centrally managed to improve the efficiency of the work to clean the administrator. Also, because the psychological burden on the users a, b, and c can be reduced by the risk management, the users a, b, and c can use the shop ST at ease.

### Fourth Embodiment

Hereinafter, a fourth embodiment of an image display device and a display system of the present invention will be described.

A display system S of the fourth embodiment is configured like the display system S of the first embodiment described above, except for differences to be described below. Accordingly, according to the display system S of the fourth embodiment, effects similar to those of the display system S of the first embodiment described above can be obtained, except for differences to be described below.

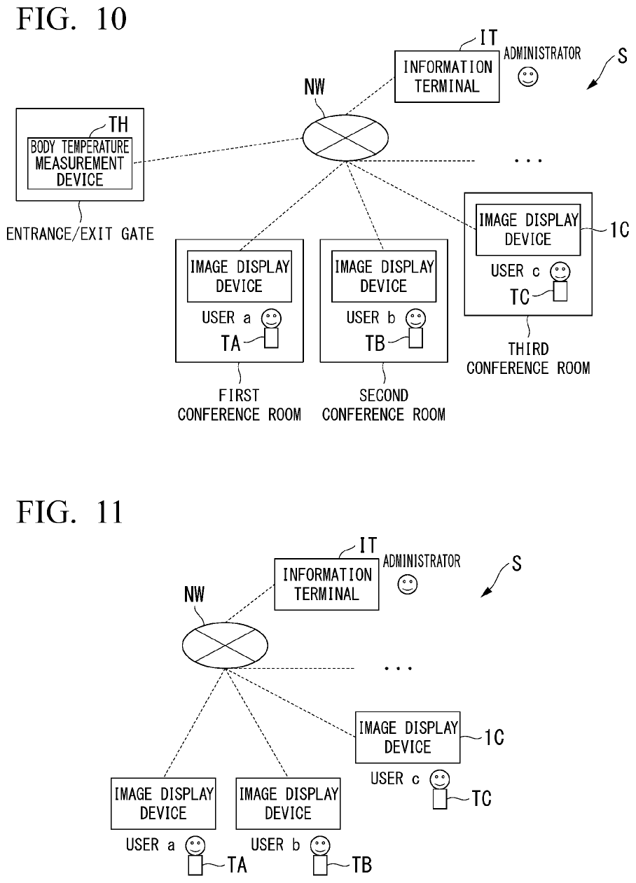

FIG. 10 is a diagram showing an example of a display system S to which image display devices 1A, 1B, and 1C of the fourth embodiment are applied.

In the example shown in FIG. 10, the display system S includes, for example, the image display device 1A, the image display device 1B, the image display device 1C, an information terminal IT, and a body temperature measurement device TH.

Although the display system S includes the three image display devices 1A, 1B, and 1C in the example shown in FIG. 10, the number of image display devices provided in the display system S may be a number other than 3 in other examples.

In the example shown in FIG. 10, the image display device 1A, the image display device 1B, the image display device 1C, and the body temperature measurement device TH are arranged in a group facility such as a company as an example. In detail, the body temperature measurement device TH is arranged at an entrance/exit gate of the company, the image display device 1A is arranged in a first conference room of the company and used as an electronic blackboard, the image display device 1B is arranged in a second conference room of the company and used as an electronic blackboard, and the image display device 1C is arranged in a third conference room of the company and used as an electronic blackboard.

In another example, the image display device 1A, the image display device 1B, the image display device 1C, and the body temperature measurement device TH may be arranged in an educational facility such as, for example, a school or a cram school. In this example, the body temperature measurement device TH is arranged at an entrance/exit gate of an educational facility, the image display device 1A is arranged in a first classroom of the educational facility and used as an electronic blackboard, the image display device 1B is arranged in a second classroom of the educational facility and used as an electronic blackboard, and the image display device 1C is arranged in a third classroom of the educational facility and used as an electronic blackboard.

In the example shown in FIG. 10, the image display device 1A is connected to the network NW and is used by a user a (for example, a member of a company). The image display device 1B is connected to the network NW and is used by a user b (e.g., a member of the company). The image display device 1C is connected to the network NW and is used by a user c (e.g., a member of the company).

The body temperature measurement device TH is connected to the network NW and is used by the users a, b, and c. The body temperature measurement device TH includes, for example, a thermal camera and the like, and measures body temperatures of the users a, b, and c.

The information terminal IT is connected to the network NW and is used by the administrator of the image display device 1A, the image display device 1B, and the image display device 1C (for example, a cleaning staff member for the image display device 1A, the image display device 1B, and the image display device 1C).

As in the example shown in FIG. 2, the image display device 1A includes, for example, a display screen 11, a touch position detection unit 12, a near field communication unit 13, a storage unit 14, and a determination unit 15.

The display screen 11 displays an image (for example, an image used for description in a conference, a class, or the like). The display screen 11 includes a touch switch 11A. The touch switch 11A receives, for example, an input operation of the user a and the like using the image display device 1A.

The touch position detection unit 12 detects the touch position and the number of touches of the display screen 11 touched by the user a.

The near field communication unit 13 acquires health management information of the user a from the portable terminal TA (see FIG. 10) located in close proximity to the image display device 1A. The portable terminal TA is, for example, a smartphone, a wearable device, or the like carried by the user a.

The storage unit 14 stores the touch position and the number of touches of the display screen 11 detected by the touch position detection unit 12, the health management information of the user a acquired by the near field communication unit 13, and the body temperature of the user a measured by the body temperature measurement device TH.

The determination unit 15 determines the degree of contamination of the display screen 11 on the basis of the touch position and the number of touches of the display screen 11, the health management information of the user a, and the body temperature of the user a stored in the storage unit 14. The determination unit 15 may determine the degree of contamination of the display screen 11 by performing a process of assigning a weight to the health management information of the user a acquired by the near field communication unit 13 or the body temperature of the user a measured by the body temperature measurement device TH.

In the example shown in FIG. 10, the image display device 1B is configured like the image display device 1A. That is, the image display device 1B includes, for example, a display screen 11, a touch position detection unit 12, a near field communication unit 13, a storage unit 14, and a determination unit 15.

The display screen 11 of the image display device 1B displays an image. The display screen 11 includes a touch switch 11A. The touch switch 11A receives, for example, input operations of the user b and the like using the image display device 1B.

The touch position detection unit 12 of the image display device 1B detects the touch position and the number of touches of the display screen 11 touched by the user b.

The near field communication unit 13 of the image display device 1B acquires health management information of the user b from the portable terminal TB (see FIG. 10) located in close proximity to the image display device 1B.

The storage unit 14 of the image display device 1B stores the touch position and the number of touches of the display screen 11 detected by the touch position detection unit 12, the health management information of the user b acquired by the near field communication unit 13, and the body temperature of the user b measured by the body temperature measurement device TH.

The determination unit 15 of the image display device 1B determines the degree of contamination of the display screen 11 on the basis of the touch position and the number of touches of the display screen 11, the health management information of the user b, and the body temperature of the user b stored in the storage unit 14.

In another example, the configuration of the image display device 1B may be different from the configuration of the image display device 1A.

In the example shown in FIG. 10, the image display device 1C is configured like the image display device 1A. That is, the image display device 1C includes, for example, a display screen 11, a touch position detection unit 12, a near field communication unit 13, a storage unit 14, and a determination unit 15.

The display screen 11 of the image display device 1C displays an image. The display screen 11 includes a touch switch 11A. The touch switch 11A receives, for example, input operations of the user c and the like using the image display device 1C.

The touch position detection unit 12 of the image display device 1C detects the touch position and the number of touches of the display screen 11 touched by the user c.

The near field communication unit 13 of the image display device 1C acquires health management information of the user c from the portable terminal TC (see FIG. 10) located in close proximity to the image display device 1C.

The storage unit 14 of the image display device 1C stores the touch position and the number of touches of the display screen 11 detected by the touch position detection unit 12, the health management information of the user c acquired by the near field communication unit 13, and the body temperature of the user c measured by the body temperature measurement device TH.

The determination unit 15 of the image display device 1C determines the degree of contamination of the display screen 11 on the basis of the touch position and the number of touches of the display screen 11, the health management information of the user c, and the body temperature of the user c stored in the storage unit 14.

In another example, the configuration of the image display device 1C may be different from the configuration of the image display device 1A.

In the example shown in FIG. 10, the information terminal IT connected to the image display device 1A, the image display device 1B, the image display device 1C, and the body temperature measurement device TH via the network NW centrally manages a degree of contamination of the display screen 11 of the image display device 1A determined by the determination unit 15 of the image display device 1A (in detail, a degree of risk of the display screen 11 of the image display device 1A in which the body temperature of the user a is reflected), a degree of contamination of the display screen 11 of the image display device 1B determined by the determination unit 15 of the image display device 1B (in detail, a degree of risk of the display screen 11 of the image display device 1B in which the body temperature of the user b is reflected), and a degree of contamination of the display screen 11 of the image display device 1C determined by the determination unit 15 of the image display device 1C (in detail, a degree of risk of the display screen 11 of the image display device 1C in which the body temperature of the user c is reflected).

The information terminal IT determines whether or not it is necessary to clean the display screens 11 of the image display devices 1A, 1B, and 1C on the basis of the degrees of contamination of the display screens 11 of the image display devices 1A, 1B, and 1C determined by the determination units 15 of the image display devices 1A, 1B, and 1C. When it is necessary to clean the display screens 11 of the image display devices 1A, 1B, and 1C, the information terminal IT provides a notification for prompting someone or something to clean the display screens 11 of the image display devices 1A, 1B, and 1C.

As described above, in the display system S of the fourth embodiment, the degrees of contamination (the degrees of risk) of the display screens 11 of the image display devices 1A, 1B, and 1C are analyzed on the basis of the touch positions and the number of touches of the display screens 11 of the image display devices 1A, 1B, and 1C, the health management information of the users a, b, and c, and the body temperatures of the users a, b, and c.

Also, in the display system S of the fourth embodiment, in a group facility that requires centralized management of the plurality of image display devices 1A, 1B, and 1C, it is possible to clarify which of the image display devices 1A, 1B, and 1C needs to be preferentially cleaned even if a plurality of users a, b, and c use the plurality of image display devices 1A, 1B, and 1C and it is possible to significantly improve the workability of a cleaning staff member.

### Fifth Embodiment

Hereinafter, a fifth embodiment of an image display device and a display system of the present invention will be described.

A display system S of the fifth embodiment is configured like the display system S of the first embodiment described above, except for differences to be described below. Accordingly, according to the display system S of the fifth embodiment, effects similar to those of the display system S of the first embodiment described above can be obtained, except for differences to be described below.

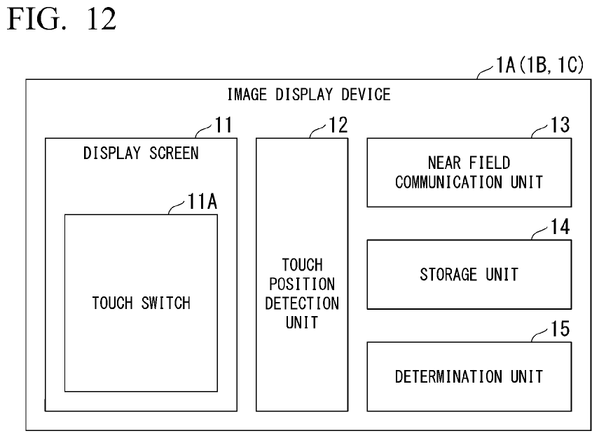

FIG. 11 is a diagram showing an example of the display system S to which image display devices 1A, 1B, and 1C of the fifth embodiment are applied. FIG. 12 is a diagram showing an example of the image display devices 1A (1B or 1C) of the fifth embodiment.

In the examples shown in FIGS. 11 and 12, the display system S includes, for example, the image display device 1A, the image display device 1B, the image display device 1C, and an information terminal IT.

Although the display system S includes the three image display devices 1A, 1B, and 1C in the examples shown in FIGS. 11 and 12, the number of image display devices provided in the display system S may be a number other than 3 in other examples.

In the examples shown in FIGS. 11 and 12, the image display device 1A, the image display device 1B, and the image display device 1C are arranged in vending machines (including automatic ticketing machines) installed in a station, a complex or the like.

The image display device 1A is connected to a network NW and is used by a user a (for example, a user of a first vending machine). The image display device 1B is connected to the network NW and is used by a user b (for example, a user of a second vending machine). The image display device 1C is connected to the network NW and is used by a user c (for example, a user of a third vending machine).

The information terminal IT is connected to the network NW and is used by an administrator of the image display device 1A, the image display device 1B, and the image display device 1C (for example, a cleaning staff member for the image display device 1A, the image display device 1B, and the image display device 1C).

As shown in FIG. 12, the image display device 1A includes, for example, a display screen 11, a touch position detection unit 12, a near field communication unit 13, a storage unit 14, and a determination unit 15.

The display screen 11 displays an image (for example, an image for describing a product that is sold in the first vending machine). The display screen 11 includes a touch switch 11A. The touch switch 11A receives, for example, input operations of the user a and the like using the image display device 1A.

The touch position detection unit 12 detects a touch position and the number of touches of the display screen 11 touched by the user a.

The near field communication unit 13 acquires health management information of the user a from the portable terminal TA (see FIG. 11) located in close proximity to the image display device 1A. The portable terminal TA is, for example, a smartphone, a wearable device, or the like carried by the user a.

The storage unit 14 stores the touch position and the number of touches of the display screen 11 detected by the touch position detection unit 12 and the health management information of the user a acquired by the near field communication unit 13.

The determination unit 15 determines a degree of contamination of the display screen 11 on the basis of the touch position and the number of touches of the display screen 11 and the health management information of the user a stored in the storage unit 14.

In the examples shown in FIGS. 11 and 12, the image display device 1B is configured like the image display device 1A. That is, the image display device 1B includes, for example, a display screen 11, a touch position detection unit 12, a near field communication unit 13, a storage unit 14, and a determination unit 15.

The display screen 11 of the image display device 1B displays an image (for example, an image for describing a product that is sold in the second vending machine). The display screen 11 includes a touch switch 11A. The touch switch 11A receives, for example, input operations of the user b and the like using the image display device 1B.

The touch position detection unit 12 of the image display device 1B detects a touch position and the number of touches of the display screen 11 touched by the user b.

The near field communication unit 13 of the image display device 1B acquires health management information of the user b from the portable terminal TB (see FIG. 11) located in close proximity to the image display device 1B.

The storage unit 14 of the image display device 1B stores the touch position and the number of touches of the display screen 11 detected by the touch position detection unit 12 and health management information of the user b acquired by the near field communication unit 13.

The determination unit 15 of the image display device 1B determines a degree of contamination of the display screen 11 on the basis of the touch position and the number of touches of the display screen 11 and the health management information of the user b stored in the storage unit 14.

In another example, the configuration of the image display device 1B may be different from the configuration of the image display device 1A.

In the examples shown in FIGS. 11 and 12, the image display device 1C is configured like the image display device 1A. That is, the image display device 1C includes, for example, a display screen 11, a touch position detection unit 12, a near field communication unit 13, a storage unit 14, and a determination unit 15.

The display screen 11 of the image display device 1C displays an image (for example, an image for describing a product that is sold in the third vending machine). The display screen 11 includes a touch switch 11A. The touch switch 11A receives, for example, input operations of the user c and the like using the image display device 1C.

The touch position detection unit 12 of the image display device 1C detects the touch position and the number of touches of the display screen 11 touched by the user c.

The near field communication unit 13 of the image display device 1C acquires health management information of the user c from the portable terminal TC (see FIG. 1) located in close proximity to the image display device 1C.

The storage unit 14 of the image display device 1C stores the touch position and the number of touches of the display screen 11 detected by the touch position detection unit 12 and health management information of the user c acquired by the near field communication unit 13.

The determination unit 15 of the image display device 1C determines a degree of contamination of the display screen 11 on the basis of the touch position and the number of touches of the display screen 11 and the health management information of the user c stored in the storage unit 14.

In another example, the configuration of the image display device 1C may be different from the configuration of the image display device 1A.

In the examples shown in FIGS. 11 and 12, the information terminal IT connected to the image display device 1A, the image display device 1B, and the image display device 1C via the network NW centrally manages the degree of contamination of the display screen 11 of the image display device 1A determined by the determination unit 15 of the image display device 1A, the degree of contamination of the display screen 11 of the image display device 1B determined by the determination unit 15 of the image display device 1B, and the degree of contamination of the display screen 11 of the image display device 1C determined by the determination unit 15 of the image display device 1C.

The information terminal IT determines whether or not it is necessary to clean the display screens 11 of the image display devices 1A, 1B, and 1C on the basis of the degrees of contamination of the display screens 11 of the image display devices 1A, 1B, and 1C determined by the determination units 15 of the image display devices 1A, 1B, and 1C. When it is necessary to clean the display screens 11 of the image display devices 1A, 1B, and 1C, the information terminal IT provides a notification for prompting someone or something to clean the display screens 11 of the image display devices 1A, 1B, and 1C.

After the information terminal IT provides a notification for prompting someone or something to clean the display screens 11 of the image display devices 1A, 1B, and 1C, the image display devices 1A, 1B, and 1C display content indicating that an input operation on the touch switch 11A is unnecessary on the display screens 11 without performing a display process of requesting the users a, b, and c to perform an input operation on the touch switch 11A until cleaning of the display screens 11 of the image display devices 1A, 1B, and 1C is completed.

In another example of the display system S of the fifth embodiment, the display screens 11 of the image display devices 1A, 1B, and 1C may display images for prompting the users a, b, and c who touch the display screens 11 of the image display devices 1A, 1B, and 1C to pay attention.

Although modes for carrying out the present invention has been described above using embodiments, the present invention is not limited to such embodiments in any way, and various modifications and substitutions can be made without deviating from the spirit and scope of the present invention. The configurations described in the embodiments and the examples described above may be appropriately combined.

Also, all or some functions of the parts provided in the display system S in the above-described embodiment may be implemented by recording a program for implementing the functions on a computer-readable recording medium and causing a computer system to read and execute the program recorded on the recording medium. Also, the “computer system ” used herein is assumed to include an operating system (OS) and hardware such as peripheral equipment.

Also, the “computer-readable recording medium” refers to a flexible disk, a magneto-optical disc, a read only memory (ROM), a portable medium such as a compact disc (CD)-ROM, or a storage device such as a hard disk embedded in the computer system. Furthermore, the “computer-readable recording medium” may include a computer-readable recording medium for dynamically holding the program for a short time period as in a communication line when the program is transmitted via a network such as the Internet or a communication circuit such as a telephone circuit and a computer-readable recording medium for holding the program for a given time period as in a volatile memory inside the computer system serving as a server or a client when the program is transmitted. Also, the above-described program may be a program for implementing some of the above-described functions. Furthermore, the above-described program may be a program capable of implementing the above-described function in combination with a program already recorded on the computer system.

### Reference Signs List

S Display system
1A, 1B, 1C Image display device
11 Display screen
11A, 11B, 11C, 11D Touch switch
12 Touch position detection unit
13 Near field communication unit
14 Storage unit
15 Determination unit
16 Transmission unit
17 Sound collection unit
18 Imaging unit
TA, TB, TC Portable terminal
NW Network
IT Information terminal
TH Body temperature measurement device
FA Exhibition facility
ST Shop

What is claimed is:

1. An image display device having a display screen for displaying an image, the image display device comprising:
a touch switch arranged on the display screen;
a touch position detection unit configured to detect a touch position and the number of touches of the touch switch touched by a user of the image display device;
a storage unit configured to store the touch position and the number of touches detected by the touch position detection unit; and
a determination unit configured to determine a degree of contamination of the display screen on the basis of the touch position and the number of touches stored in the storage unit.

2. The image display device according to claim 1, further comprising:
a near field communication unit configured to acquire health management information of the user from a portable terminal located in close proximity to the image display device,
wherein the storage unit is configured to store the health management information of the user acquired by the near field communication unit, and
wherein the determination unit is configured to determine the degree of contamination of the display screen on the basis of the touch position and the number of touches of the user stored in the storage unit and the health management information of the user acquired by the near field communication unit.

3. The image display device according to claim 1, wherein the display screen includes a plurality of touch switches.

4. The image display device according to claim 1,
wherein the image display device is configured to determine a part, of the touch switch, which needs to be cleaned, on the basis of the degree of contamination determined by the determination unit, and
wherein the image display device further comprises:
a transmission unit configured to transmit information indicating the part, of the touch switch, which needs to be cleaned.

5. The image display device according to claim 1,
wherein the touch position detection unit is configured to detect, for each of a plurality of users, a touch position and the number of touches touched by each user,
wherein the determination unit is configured to determine, for each of the plurality of users, a respective degree of contamination of the touch position touched by each user on the basis of the touch position and the number of touches touched by each user and health management information of each of the plurality of users,
wherein the determination unit is configured to determine a part, of the touch switch, which needs to be cleaned within the touch switch on the basis of the degree of contamination of the touch position touched by each of the plurality of users determined for each user, and
wherein the image display device comprises:
a transmission unit configured to transmit information indicating the part, of the touch switch, which needs to be cleaned.

6. The image display device according to claim 1, further comprising:
a sound collection unit configured to collect a voice produced by the user; and
an imaging unit configured to capture an image of the user,
wherein the storage unit stores the voice produced by the user collected by the sound collection unit and the image of the user captured by the imaging unit,
wherein the determination unit is configured to determine the degree of contamination of the display screen on the basis of the voice produced by the user and the image of the user, and
wherein the determination unit is configured to determine whether or not the user is wearing a mask on the basis of the image of the user stored in the storage unit and determines a droplet risk on the basis of the voice produced by the user stored in the storage unit.

7. The image display device according to claim 6,
wherein the image display device is configured to determine a part that needs to be cleaned within the touch switch on the basis of the degree of contamination determined by the determination unit, and
wherein the image display device further comprises:
a transmission unit configured to transmit information indicating the part, of the touch switch, which needs to be cleaned.

8. A display system comprising:
a first image display device having a first display screen for displaying an image; and
a second image display device having a second display screen for displaying an image,
wherein the first image display device comprises:
a first touch switch arranged on the first display screen;
a first touch position detection unit configured to detect a touch position and the number of touches of the first touch switch touched by a first user who is a user of the first image display device;
a first storage unit configured to store the touch position and the number of touches detected by the first touch position detection unit; and
a first determination unit configured to determine a degree of contamination of the first display screen on the basis of the touch position and the number of touches stored in the first storage unit,
wherein the second image display device comprises:
a second touch switch arranged on the second display screen;
a second touch position detection unit configured to detect a touch position and the number of touches of the second touch switch touched by a second user who is a user of the second image display device;
a second storage unit configured to store the touch position and the number of touches detected by the second touch position detection unit; and
a second determination unit configured to determine a degree of contamination of the second display screen on the basis of the touch position and the number of touches stored in the second storage unit, and
wherein the first degree of contamination of the first display screen determined by the first determination unit and the second degree of contamination of the second display screen determined by the second determination unit are collected via a network and the first image display device and the second image display device are centrally managed.

9. The display system according to claim 8,
wherein the first image display device further comprises:
a first near field communication unit configured to acquire health management information of the first user from a first portable terminal located in close proximity to the first image display device,
wherein the first storage unit is configured to store the health management information of the first user acquired by the first near field communication unit,
wherein the first determination unit is configured to determine the degree of contamination of the first display screen on the basis of the touch position, the number of touches, and the health management information of the first user stored in the first storage unit,
wherein the second image display device further comprises:
a second near field communication unit configured to acquire health management information of the second user from a second portable terminal located in close proximity to the second image display device,
wherein the second storage unit is configured to store the health management information of the second user acquired by the second near field communication unit, and
wherein the second determination unit is configured to determine the degree of contamination of the second display screen on the basis of the touch position, the number of touches, and the health management information of the second user stored in the second storage unit.

10. The display system according to claim 8, comprising:
an information terminal configured to collect the first degree of contamination of the first display screen determined by the first determination unit and the second degree of contamination of the second display screen determined by the second determination unit and centrally manage the first image display device and the second image display device,
wherein the information terminal is connected via the network to the first image display device and to the second image display device,
wherein the information terminal is configured to provide a first notification for prompting someone or something to clean the first display screen when it is necessary to clean the first display screen, and
wherein the information terminal is configured to provide a second notification for prompting someone or something to clean the second display screen when it is necessary to clean the second display screen.

11. The display system according to claim 10,
wherein the first image display device is configured to prevent a display process of requesting an input operation on the first touch switch from being performed until cleaning of the first display screen is completed after the information terminal provides the notification for prompting someone or something to clean the first display screen, and
wherein the second image display device is configured to prevent a display process of requesting an input operation on the second touch switch from being performed until cleaning of the second display screen is completed after the information terminal provides the notification for prompting someone or something to clean the second display screen.

12. The display system according to claim 10,
wherein the first image display device is configured to prohibit an input operation on the first touch switch until cleaning of the first display screen is completed after the information terminal provides the notification for prompting someone or something to clean the first display screen, and
wherein the second image display device is configured to prohibit an input operation on the second touch switch until cleaning of the second display screen is completed after the information terminal provides the notification for prompting someone or something to clean the second display screen.

13. The display system according to claim 10,
wherein the first image display device is configured to prevent a display process of the first display screen from being performed until cleaning of the first display screen is completed after the information terminal provides the notification for prompting someone or something to clean the first display screen, and
wherein the second image display device is configured to prevent a display process of the second display screen from being performed until cleaning of the second display screen is completed after the information terminal provides the notification for prompting someone or something to clean the second display screen.

14. The display system according to claim 9, further comprising:
a body temperature measurement device configured to measure at least body temperatures of the first user and the second user;
wherein the first storage unit is configured to store the touch position and the number of touches detected by the first touch position detection unit, the health management information of the first user acquired by the first near field communication unit, and the body temperature of the first user measured by the body temperature measurement device,
wherein the second storage unit is configured to store the touch position and the number of touches detected by the second touch position detection unit, the health management information of the second user acquired by the second near field communication unit, and the body temperature of the second user measured by the body temperature measurement device,
wherein the first determination unit is configured to determine the degree of contamination of the first display screen on the basis of the touch position, the number of touches, the health management information of the first user, and the body temperature of the first user stored in the first storage unit, and
wherein the second determination unit is configured to determine the degree of contamination of the second display screen on the basis of the touch position, the number of touches, the health management information of the second user, and the body temperature of the second user stored in the second storage unit.
